(19) United States
(12) Patent Application Publication
(10) Pub. No.: US 2021/0209608 A1
(43) Pub. Date: Jul. 8, 2021

(54) MULTI-FACTOR AUTHENTICATION SYSTEM AND METHOD OF USE THEREOF

(71) Applicant: Perry Craig Harrison, Harrisburg, PA (US)

(72) Inventor: Perry Craig Harrison, Harrisburg, PA (US)

(21) Appl. No.: 17/191,340

(22) Filed: Mar. 3, 2021

(51) Int. Cl. G06Q 20/40; G06F 21/32; G06Q 20/36; G06K 9/00

(52) U.S. Cl. CPC G06Q 20/40145; G06F 21/32; G06Q 20/36; G06K 9/00892; G10L 17/00; G06K 9/00268; G06K 9/00288; G06K 9/00087; G06Q 2220/00

(57) ABSTRACT

A system for multi-factor authentication of digital transactions, including crypto wallets. The system comprising verifying three biometric modalities of a user. The three biometric modalities include fingerprint, facial features, and voice sample analysis.

### FIELD OF INVENTION

The present invention relates to a system and method for Multi-factor authentication and in particular the system and method of three-part verification for crypto wallets.

### BACKGROUND

Digital transactions are on a rise every day, and more people are switching to digital transactions in some parts of their lives. Cryptocurrency is replacing hard money because Cryptocurrency is more convenient to transact. However, along with the increasing volume of digital transactions, also are increasing the incidents of frauds, identity thefts, and hacks. Generally, most digital transactions, such as a crypto wallet are secured by alphanumeric passwords. The usernames and passcodes are a weaker form of authentication that can be easily compromised.

Thus, a need is appreciated for multi-factor biometric authentication for crypto wallets and high-value digital transactions.

### SUMMARY OF THE INVENTION

The following presents a simplified summary of one or more embodiments of the present invention in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments in a simplified form as a prelude to the more detailed description that is presented later.

The principal object of the present invention is directed to a crypto wallet that includes multifactor authentication.

It is another object of the present invention to provide for multi-factor authentication for digital transactions.

It is still another object of the present invention that system prevents frauds and hacks.

It is yet another object of the present invention that the system is compatible with a range of electronic devices.

It is a further object of the present invention that the system is versatile and economical.

In one aspect, disclosed is a system for multi-factor authentication of digital transactions, including crypto wallets. The system can verify an identity of a user while foregoing the need for usernames and passwords.

In one aspect, the disclosed system and method can provide for a combination of fingerprint, facial recognition, and voice recognition for the verification of a person's transmission using an electronic device.

These and other objects, advantages of the embodiments herein, and the summary will become readily apparent from the following detailed description taken in conjunction with the accompanying drawings

### BRIEF DESCRIPTION OF DRAWINGS

The accompanying figures, which are incorporated herein, form part of the specification and illustrate embodiments of the present invention. Together with the description, the figures further explain the principles of the present invention and to enable a person skilled in the relevant arts to make and use the invention.

FIG. 1 is a block diagram showing the disclosed system, according to an exemplary embodiment of the present invention.

FIG. 2 is a flow chart showing an exemplary embodiment of the disclosed method for verifying an identity of a user for performing an activity, according to the present invention.

### DESCRIPTION

Subject matter will now be described more fully hereinafter with reference to the accompanying drawings, which form a part hereof, and which show, by way of illustration, specific exemplary embodiments. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, the subject matter may be embodied as methods, devices, components, or systems. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not necessarily require that all embodiments of the invention include the discussed feature, advantage, or mode of operation.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely for the purpose of illustrating the general principles of the invention, since the scope of the invention will be best defined by the allowed claims of any resulting patent.

Disclosed is a system and method for multi-factor authentication for verifying a user's access in digital transactions, such as login to a secured account or approve a monetary or non-monetary transaction. For example, the disclosed multi-factor authentication can be used for crypto wallets, bank accounts, email accounts, and like. Username and passwords may no longer be required, thus no more forgotten or expired passwords. The disclosed system can be implemented in different user devices, such as laptops, desktops, mobile phones, servers, tablet computers, smartwatches, and like. This disclosed system can prevent unauthorized access to secure accounts and prevents fraudulent transactions. The disclosed system can provide better and more easily implemented security than the usernames and passwords, as the usernames and passwords can be easily stolen or hacked. Also, the hackers may imitate any of the biometric data, such as fingerprints can be hacked. However, the disclosed invention provides a combination of biometric data that is too difficult or impossible to be hacked. Moreover, the disclosed system may also have hardware-level security known in the art for providing secure access to digital transactions.

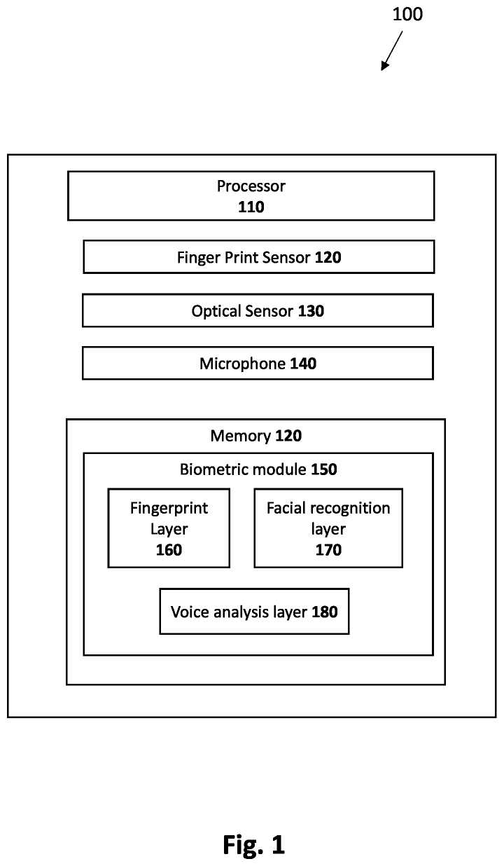

Referring to FIG. 1, which shows an exemplary embodiment of the disclosed system 100 having a processor 110 and a memory 120 in electric communication with the processor 110. The system 100 may be connected to a fingerprint sensor 120, an optical sensor 130 for facial recognition, and a microphone 140. The memory 120 includes a biometric module 150 configured to take and verify the biometric data of a user. The biometric module includes a fingerprint layer 160, a facial recognition layer 170, and a voice analysis layer 180. The fingerprint layer, upon execution by the processor 110, can receive through the fingerprint sensor 120, a fingerprint impression of a user. The facial recognition layer 170, upon execution by the processor 110, can through the optical scanner 130 recognize the facial features. The voice analysis layer 180, upon execution by the processor 110, can receive a voice sample for analysis.

At first, a user may register his biometrics using the disclosed system 100. The registered biometrics can be associated with different applications, accounts, or digital transactions. The digital transaction can be monetary involving the transfer of money, or non-monetary such as accepting a contract. The same biometric module can be used for different applications, accounts, and transactions on the system. The system can connect to an internal or external database for securely storing the biometric data. Preferably, the biometric data can be encrypted to prevent any unauthorized access. To gain access to an account or approve a transaction, the disclosed biometric module may request the three biometric details from a user.

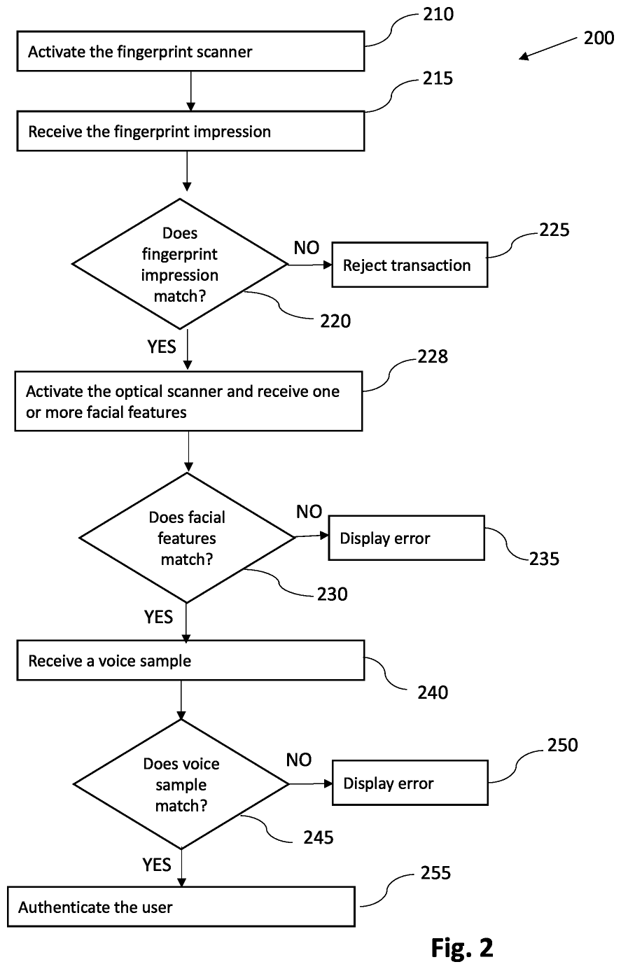

Referring to FIG. 2, which shows an exemplary embodiment of the biometric module 200 for verifying an identity of a user. At first, the fingerprint layer of the biometric module can be executed by the processor to activate the fingerprint scanner, at step 210. The fingerprint layer can request the user to place his registered finger or thumb on the scanner. The fingerprint layer can then receive the fingerprint impression of a user, at step 215. The biometric module can then check if the received fingerprint impression matches with the registered fingerprint scanner of the user, at step 220. If the match fails, the transaction can be rejected, at step 225. If the match can be made, the face recognition layer can activate the optical scanner, at step 228. The user may be requested to bring the optical scanner in front of the face for scanning one or more facial features. The facial features may also include retina scan, iris blood vessels color tones, etc. The biometric module may verify the received facial features with the registered facial features, at step 230. In case, the facial features are not matched, the biometric module can display an error, at step 235. On error, the user may again verify the facial recognition feature. If the facial features are matched, the voice recognition layer may receive a voice sample, at step 240. The voice recognition layer may display text which can be read by the user. The biometric module may verify the voice sample, at step 245 by matching it against the registered voice sample. In case the match fails, an error message can be displayed, at step 250. On successful verification, the disclosed system can authenticate the user for accessing the application or approving a transaction, at step 255. Alternatively, the system can receive oral answers to a set of questions at the time of registration. For verification, the system may through display or voice can ask a few random questions from the set of questions. The user can answer the questions orally, wherein the disclosed system can both verify the voice and the answer given or provided via the registered voice and answer.

In case of a two-party transaction, such as signing a contract between two persons, the system may send a request to verify the three biometric factors of the second party as well. Similarly, any third party can also be verified by using disclosed system. Additionally, a user may have any one of the three biometric factors degenerate, such as degenerating of fingerprint impression due to certain occupation, dry skin issue in winters, and any unfortunate incidence like amputation of the finger. Similarly, the voice of a user may get affected by aging or pathophysiological changes. Facial features may also alter with aging or pathophysiological changes. Thus, the failure of any one of the three biometric factors cannot be ruled out. To take care of such a situation, a third-party secure server can be configured to override the three-factor authentication. The third-party server may allow disabling the biometric authentication and reverting the verification process to another method, such as a passcode or the use of a different biometric modality. The third-party secure server may also provide for disabling a user device, for example in case the user device is lost, the third-party secure server can disable the device for performing any transaction.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. A method for verifying a user's identity to perform an activity, the method comprising the steps of:
receiving, by the system, through a fingerprint scanner, a fingerprint impression of a finger of a user;
upon receiving the fingerprint impression, verifying the fingerprint impression with a registered fingerprint impression of the user;
upon verification of the fingerprint impression, receiving, by the system, through an optical sensor, one or more images of the user's face;
extracting, by the system, facial features from the one or more images of the face;
matching, by the system, the facial features with the registered facial features of the user;
upon verification of the facial features, receiving a voice sample of the user's voice;
matching, by the system, the voice sample with a registered voice sample of the user; and
upon verification of the voice sample, permitting a user to perform the activity.

2. The method according to claim 1, wherein the activity is accessing a crypto wallet.

3. The method according to claim 1, wherein the activity is accepting a contract between two parties, wherein the system verifies a second party also.

4. The method according to claim 1, wherein the activity is approving a financial transaction.

5. The method according to claim 1, wherein the user is permitted to perform the activity when fingerprint impression, the facial features, and the voice sample analysis are successfully verified.

6. The method according to claim 1, wherein the method further comprises a step of:
permitting, by the system, a third-party server to override the one or more steps of the verification of the user.

7. The method according to claim 1, wherein the voice sample is obtained through a microphone.

8. The method according to claim 7, wherein the method further comprises the step of:
Presenting by the system, a text to the user for reading,
wherein the voice sample corresponds to the text.

9. A method for verifying a user's identity to perform an activity, the method comprising the steps of:
receiving, by the system, through a fingerprint scanner, a fingerprint impression of a finger of a user;
upon receiving the fingerprint impression, verifying the fingerprint impression with a registered fingerprint impression of the user;
upon verification of the fingerprint impression, receiving, by the system, through an optical sensor, one or more images of the user's face;
extracting, by the system, facial features from the one or more images of the face;
matching, by the system, the facial features with the registered facial features of the user;
upon verification of the facial features, receiving oral answers to a plurality of questions from the user, the plurality of questions randomly selected from a set of questions pre-registered with the system, wherein voice and answers of the oral answers are matched with the registered voice and answers; and
upon verification of the oral answers, permitting a user to perform the activity.
